(19) United States
(12) Patent Application Publication
(10) Pub. No.: US 2012/0057614 A1
(43) Pub. Date: Mar. 8, 2012

(54) Geothermal temperature gradient measurement

(76) Inventor: Randy Allen Normann, Edgewood, NM (US)

(21) Appl. No.: 12/807,421

(22) Filed: Sep. 3, 2010

(51) Int. Cl. G01K 13/00; G01K 3/00

(52) U.S. Cl. 374/112; 374/136; 374/E13.001; 374/E03.001

(57) ABSTRACT

A new method for measuring the temperature gradient of a well is claimed. This method uses multiple and parallel temperature sensors to calculate the well's temperature at each point in the well. This reduces noise found in electronic measurements in order to improve the well's temperature measurement and improve the calculation of the well's temperature gradient. The use of natural background gamma enhances the calculation of the well's temperature gradient and improves the detection of changing rock formations intersecting the well.

### TECHNICAL FIELD OF THE INVENTION

A means for improving the measurement of well temperature gradients to track changes in thermal conductivity of earth formations penetrated by a well.

### BACKGROUND OF THE INVENTION

There is a need within the oil and natural gas industry to measure changes in well temperature as a function of depth. As such, there are a number of methods for measuring changes in well temperature as a function of depth. This process results in the temperature gradient of the well. The need for accurate well temperature gradients is even greater within the geothermal industry. Thus, processes developed for the oil and natural gas industry are inadequate to meet the needs of the geothermal industry. The geothermal industry is interested in the small changes in rock conductivity which can be measured as the thermal gradient of the geothermal well. In the background of the invention section of this application the existing processes for measuring well temperature gradients are discussed.

In most all cases, the changes in well temperature are measured by the temperature probe (called a logging tool) being deployed down the well. Temperature measurements are recorded verses depth. These measurements can be used to detect changes in depth by plotting out the temperature measurement and conducting a visual inspection. FIG. 1 is an illustration of a temperature profile of a well. To enhance the detection of changes in the well's temperature gradient a calculation of the differential temperature per measurement of depth can be used. FIG. 2 is an illustration of the temperature gradient calculation from the well profile seen in FIG. 1. The step change is clearly visible in this example using ideal measurements and the first Delta(Tn) calculation below.

Two simple differential calculations are detailed below.

Delta(Tn)=T(n)=T(n−1); OR 1)

Delta(Tn)=(T(n+1)−T(n−1))/2; 2)

In the above equations; Delta(Tn) is the differential temperature at sample depth ‘n’. T(n) is the temperature measurement made at depth ‘n’ and T(n−1) and T(n+1) are the temperature measurements made before and after with respect to depth ‘n’.

FIG. 1 provides a simple example of a temperature well log. There is a slight change in the slope of the temperature readings at depth 200 and depth 250. A visual inspection might miss this change. After calculating the temperature gradient the change is very obvious and can be seen as a step function; as can be seen in FIG. 2. This example was created using ‘ideal’ noiseless measurements for the purpose of illustration.

Temperature gradient information is useful in the oil industry for locating the point at which fluid from the surrounding formation is entering or leaving the well. In many cases, oil entering a well is hotter than the well and cools as it moves up the well. As the logging tool moves past the fluid entry area, the well's temperature will quickly fall. In most cases, it is normal, that a fluid entry location is seen as a strong change in the temperature gradient.

An early patent on well differential well temperature measurements is number. U.S. Pat. No. 3,410,136 Differential Temperature Well Logging Apparatus, Aug. 15 1966, Earl Johns et al. Temperature gradient can also be referenced at the differential temperature.

This early patent describes the current technology being used today to measure temperature gradients in the well. As already described, an electronic well logging tool is used to make measurements as the tool moves down the well. Each measurement is saved in electronic memory aboard the logging tool. The measurements are then used to calculate the changes in well temperature as a function of well depth. This method has the issue of accuracy given the uncertainty of any one measurement. Subtracting the two measurements sums the uncertainty of each measurement together, increasing measurement uncertainty. The differential temperature measurement of interest can be very small as in ‘zero’ differential temperature is an acceptable value. As in, there wasn't any change in the temperature of the well over the measured span.

Any one measurement of temperature ‘T(n)’ is composed of the measured value plus background noise found in the measurement system.

T(n)=any one measured value of the temperature sensor

Tabs(n)=the ideal sensor temperature output at sample n

Nt(n)=normalized noise output from the temperature sensor at sample n

T(n)=Tabs(n)+Nt(n)

Differential temperature measurement is then:

Delta(Tn)=T(n)−T(n−1)

Delta(Tn)=Tabs(n)−Tabs(n−1)+Nt(n)+Nt(n−1)

As Nt(n) and Nt(n−1) are unknown values of random noise

Delta(Tn)=Tabs(2)−Tabs(1)+2*Nt(n)

Measurement noise in our temperature measurements have increased with respect to the small difference in the measured temperatures. This noise issue is a significant issue in attempting to measure the well's temperature gradient. In fact, for most geothermal well temperature gradients of 0.001° C. per foot, the measurement noise is 0.002° C. per measurement! So much so, that most temperature gradient logs use a moving average to reduce the effects of the measurement noise prior to calculating the temperature gradient. Unfortunately, the moving average also rounds out the step change in the absolute temperature reading, significantly reducing the ability of the temperature gradient calculation to detect the slight changes in rock formations.

Using the example already discussed, random Gaussian (normal) noise is added to the temperature measurements in FIG. 1. The magnitude of the noise is approximately the same as the temperature gradient. FIG. 3 shows the well temperature with noise. There is little visual difference between FIG. 3 and FIG. 1. The added noise is very small compared to the overall well temperature.

FIG. 4 shows the new temperature gradient and the significant impact the noise has on the calculated temperature gradient. It is now difficult to see where the increase in temperature gradient is occurring. A common solution to this problem is simply to take a moving average. FIG. 5 shows the new temperature gradient after a 5 point moving average was applied to the measured temperature values. This greatly reduces the impact of the noise however; the slope of the step in temperature gradient is also rounded. This is because the average is across the temperature samples produced by the probe as it moved down the well. If each measurement is three feet apart, then the described moving average is over a 15 foot distance. An illustration of the moving average equation is below.

Avg(Tn)=[T(n+2)+T(n+1)+T(n)+T(n−1)+T(n−2)]/5

where: Avg(Tn) is the average temperature at depth ‘n’ following a 5 point moving average.

T(n+2) is the second temperature measure following depth ‘n’

T(n+1) is the first temperature measurement following depth ‘n’

T(n) is the temperature measurement at depth ‘n’

T(n−1) is the temperature measurement before measurement before depth ‘n’

T(n−2) is the temperature measurement two measurement before depth ‘n’

Others have used hardware to directly measure the temperature gradient. These concepts are listed below.

U.S. Pat. No. 5,121,993 Triaxial Thermopile Array Geo-Heat-Flow Sensor, Jun. 16, 1992 Inventors: Charles R. Carrigan, Harry C. Hardee, Gerald d. Reynolds, Terry D. Steifort

This patent uses a long string of single point temperature sensing devices to track temperature changes and temperature gradients in the well. The system requires separation of the temperature sensors by several feet, making the system very long and difficult to manage. Also, by using numerous single sensors, each must be calibrated to very tight tolerances to detect small changes in well temperature. Finally, this system is best used for stationary well monitoring and not for well logging.

U.S. Pat. No. 6,957,576 Subterranean Well Pressure and Temperature Measurement, Oct. 25, 2005, Skinner et al,

This patent covers the measurement of temperature gradients using fiber optic cables. Here the fiber itself is used as a long string of single point temperature measurements. Fiber optic cables are sensitive to temperature. A number of measurement processes can be used to capture temperature values at points along a fiber optic cable, such as Bragg gradients, Raman backscatter and interferometers. This system offers the same issues as electronic measurements made in series, temperatures are smoothed by averaging, losing sufficient resolution to capture the location of formation changes.

### SUMMARY OF THE INVENTION

The invention uses a plurality of temperature sensors in place of the single temperature sensor used in a logging tool. A block diagram of a common well logging temperature tool is show in FIG. 6. FIG. 7 shows the same block diagram only now with three temperature sensors all operating at the same depth location and being sampled at the same time. By sampling all temperature sensors at one time for each depth inside the well, the need for a moving average for well temperatures is reduced or eliminated.

In the equation below, there are four temperature measurements from one of each temperature sensor; T1(n), T2(n), T3(n) and T4(n).

AvgT(n)=[T1(n)+T2(n)+T3(n)+T4(n)]/4

Knowing that each measurement is has some noise associated with it, the above equation becomes:

AvgT(n)=[(T1abs(n)+N1(n))+(T2abs(n)+N2(n))+(T3abs(n)+N3(n))+(T4abs(n)+N4(n))]/4

As the four temperature measurements are being taken at the same location within the well, the absolute value of all four measurements are the same. Knowing that the noise component for each measurement is a normal (Gaussian) random value about the absolute measured value for temperature the expression can be simplified.

AvgT(n)=Tabs(n)+[N1(n)+N2(n)+N3(n)+N4(n)]/4

In the above equation, we get an average value for temperature at each well depth ‘n’. The noise for each temperature at depth is now averaged across the four sensors. Because electronic noise has a zero mean value, the average of the noise is reduced with increasing the number of independent sensors. Four temperature measurements taken at the same point in the well reduce the noise component while protecting the absolute value. The greater the number of temperature sensors, the smaller the value for Average of N(n). A plurality of temperature sensors improves the logging tool's ability to detect small changes in rock thermal conductivity needed for geothermal wells.

Another means to detect changes in rock formation inside a well is the measurement of natural gamma radiation. All rock formations have some level of background gamma radiation based on the three naturally occurring gamma emitters: potassium (K40), uranium (U) and thorium (Th). Natural gamma background count rates in rock are statistically constant. By measuring the background count rate as a function of depth inside a well, changes in gamma readings indicate a change in rock formation. The addition of the gamma sensor is shown in FIG. 9.

An enhancement of the invention is the use of an algorithm to tie the changes in gamma background counting rates with potential changes in the well's temperature gradient. In short, a change in the gamma count rate outside of 3 standard deviations could be used to recalculate the measured temperature gradient over that section of the well. A simple algorithm is shown in FIG. 8.

Another enhancement of the invention is the addition of a second set of temperature sensors. FIG. 10 shows block diagram of a logging tool with a bull nose containing temperature sensors on both ends of the logging tool. In all cases, the bull nose is simply a metal cage for protecting the temperatures sensors from damage while allowing well fluids to flow through. In this type of tool design, the offset distances between the various sensors are known in order to correct for making a plurality of measurements at each depth, ‘n’. For example, if the offset between temperature sensors at each end of the tool is 3 ft and a temperature measurement is made every 3 feet then the rear temperature measurements are at a depth 1 sample behind.

There is another advantage of the design shown in FIG. 10. A second well temperature gradient can be made. The temperature gradient as a function of the temperature measurements made at both ends of the logging tool. Here the gradient would be temperature difference over the offset difference. Comparing this gradient measurement with already discussed will result in averaging of the two temperature gradient measurements.

### BRIEF DESCRIPTION OF THE DRAWINGS

FIG. 1. This is a graphical illustration of a well temperature profile. The well's temperature is increasing with depth.

FIG. 2. This is the calculated temperature gradient of FIG. 1. FIGS. 1 and 2 have ideal measured values.

FIG. 3. This is a repeat of FIG. 1, only now a small noise level is added to each well temperature measurement to illustrate a real world situation.

FIG. 4. The same algorithm as was used in FIG. 2, is again used to calculate the temperature gradient for values given in FIG. 3. The small amount of additive noise is making it difficult to see the small change in the temperature gradient.

FIG. 5. In order to reduce the noise in FIG. 4, a moving average was used to create data in FIG. 5. Averaging reduces the noise level at a cost of sensitivity to locating the beginning and ending of changes in thermal gradients.

FIG. 6. This is an illustration block diagram of a temperature probe logging tool used by the logging industry.

FIG. 7. This is an illustration block diagram of the invention where the temperature probe logging tool has at least three temperature sensors.

FIG. 8. This is an illustration of a simple algorithm used to improve the detection of changes in rock formation and potential changes in the well's temperature gradient.

FIG. 9. This is an illustration block diagram of a logging tool where a gamma sensor is placed inside the too

FIG. 10. This is an illustration block diagram where a second set of temperature sensors is place on top (or other end) from the set shown in FIG. 7.

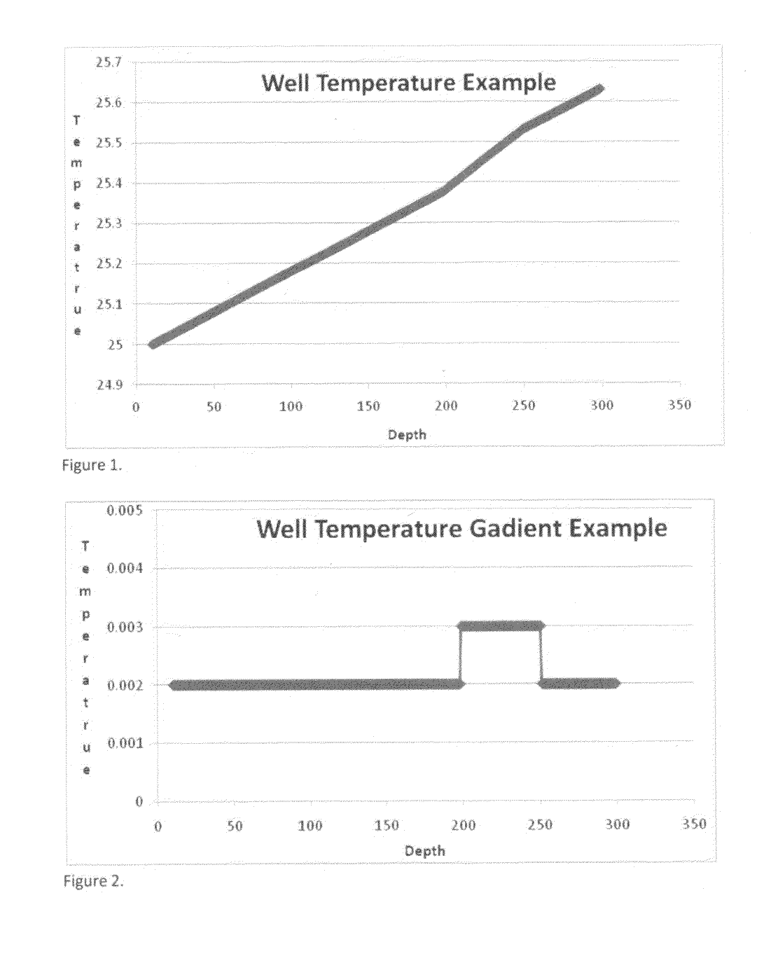

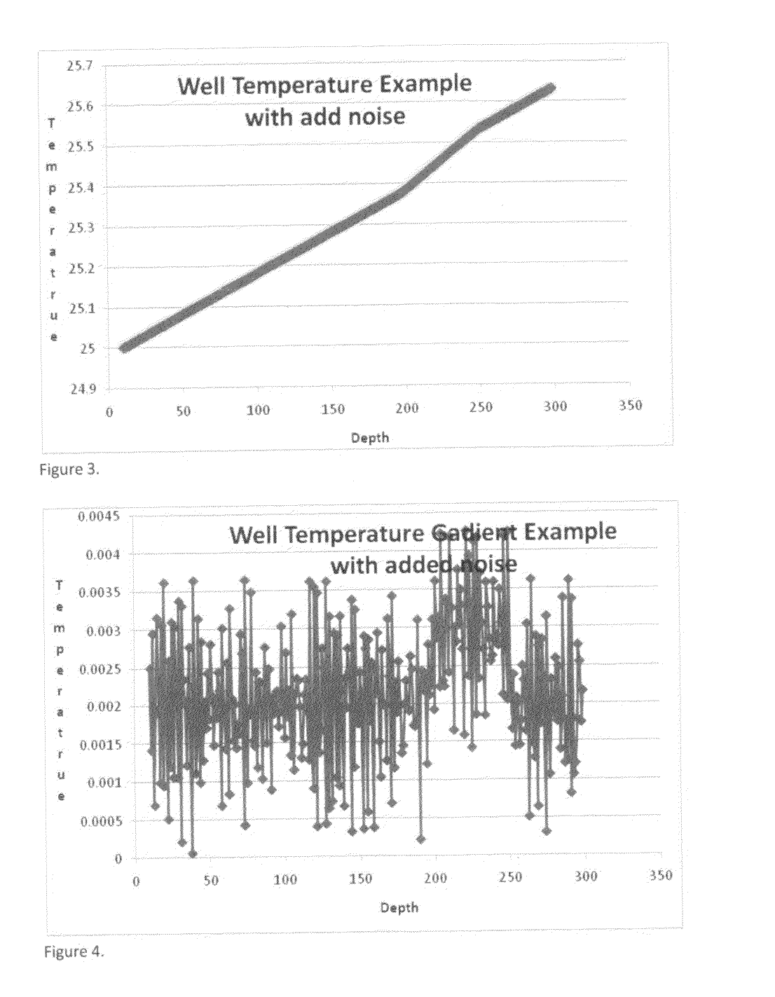

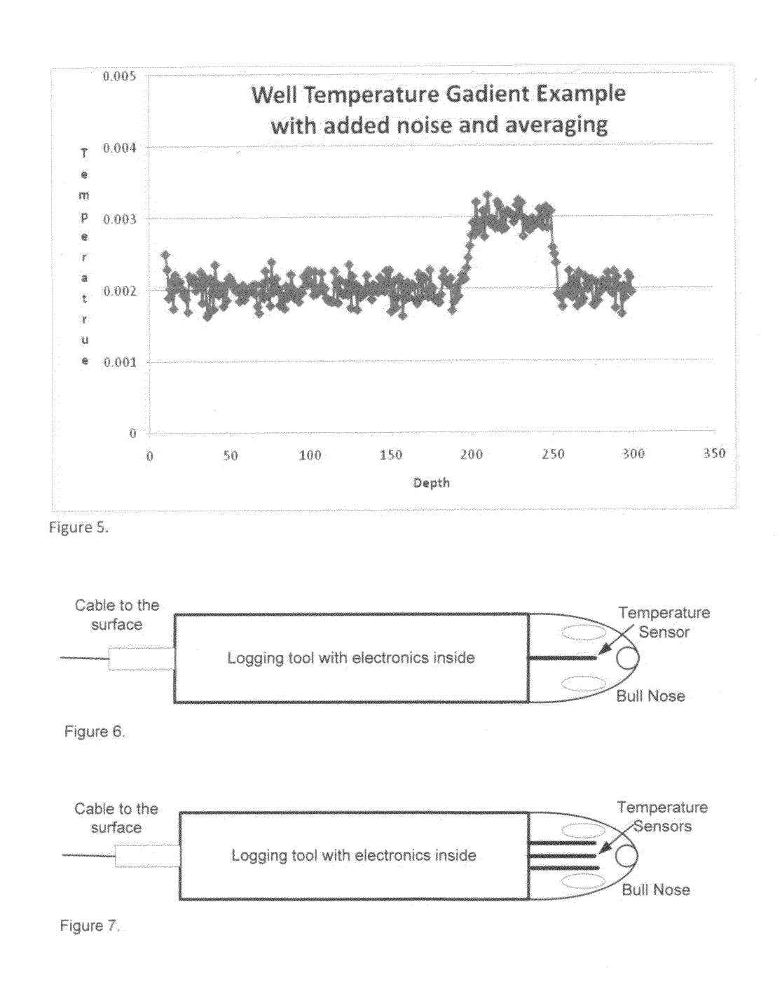

### DETAILED DESCRIPTION OF THE PRESENT INVENTION

A well logging tool used to measure well temperature has a plurality of parallel temperature sensors. Parallel sensors are mounted on the tool such that they have the same physical depth location inside the well. Using a plurality of sensors allows the logging tool to simultaneously measure well temperature using independent measurement electronic components and sensors. This allows for averaging temperature measurements across the temperature sensors at every measurement point inside the well. This process significantly reduces the noise associated with the measurement of the well's temperature profile by averaging out electronic noise found in any one sensor measurement.

This reduction of noise allows for significantly improved calculation of the well's temperature gradient. In particular, the temperature gradient associated with changes in rock formations inside a geothermal well. Such data can be used to improve the development of geothermal energy from heat generated inside the earth.

An enhancement of the invention is the addition of a gamma sensor. Gamma is often used to track changes in rock formations by tracking changes in the gamma count measurements. Here any gamma sensor as in total count gamma or spectral gamma can be used.

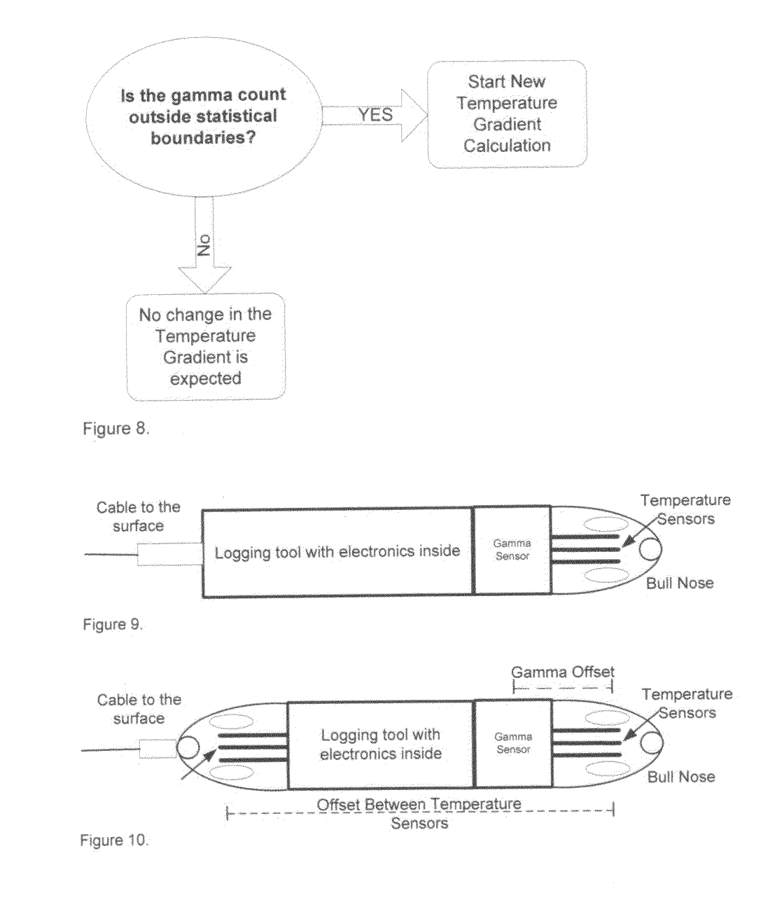

Gamma measurements are used to help identify changes in the rock formation which can potentially result in slight changes in the well's temperature gradient. A simple algorithm using the gamma measurement is suggested in FIG. 8 to better detect potential changes in well temperature gradients.

Naturally, a similar algorithm could be used to detect changes in the temperature gradient to better capture slight changes in the gamma measurements.

An additional enhancement to the invention is the use of additional temperature sensors with a known offset as seen in FIG. 10. After the offset is corrected for, those measurements could be used to increase the number of independent sensor measurements at depth ‘n’ needed to reduce noise in the temperature gradient.

The second set of multiple temperature sensors allows for the direct measurement of the well's temperature gradient by calculating the temperature difference over the offset distance. This value can be compared to the gradient measurement already discussed which is taken as the tool moves down or up the well. As example calculation is shown below.

Let TAn be the average temperature reading from a set of temperature sensors at depth ‘n’ on mounted the front of the logging tool and let TBn be the average temperature reading from the set of temperature sensors mounted on the rear of the tool. The offset between the two sets of temperature is ‘D’. The well's temperature gradient can be calculated by:

Delta(Tn)=[TAn−TBn]/D

A case for near simultaneous measurements of temperature on a plurality of sensors can be achieved if the measurements of each parallel sensor is many times faster than the rate of movement of the logging tool inside the well. For example, if each sensor is electronically sampled every 100 uS and the tool is moving at a rate of 20 feet per minute, then a sample is made every 0.00005 feet. In this case, there is so little change in the wells temperature, that it appears to have been sampled at the same time. This would eliminate the parallel electronic channels inside the logging tool.

We claim:

1. A method for measuring the temperature inside a well using a plurality of temperature sensors located such that each is measuring the well temperature at the same depth inside the well whereby averaging the temperature readings results in a reduction of electronic noise to increase measurement accuracy and sensitivity.

2. A method according to claim 1, wherein each temperature measurement is comprised from an average of two or more temperature sensors.

3. A method according to claim 1, wherein each temperature sensor is independently measured by an independent set of electronic components operating simultaneously.

4. A method according to claim 1, wherein the temperature sensors are moving up or down the well while tracking changes in well temperature against sensor well depth to determine the wells temperature gradient.

5. A method according to claim 1, wherein the well is a geothermal or water well.

6. A method according to claim 1, wherein the well is an oil or natural gas producing well.

7. A method according to claim 1, wherein the well temperature profile is used to measure the thermal gradient of rock formations intercepted by the well.

8. A method according to claim 1, wherein each temperature sensor is measured many times faster than the rate of movement of temperature sensors within the well whereby creating multiple measurements at the same relative location in the well.

9. A method for detecting changes in the wells thermal gradient using a combination of gamma and temperature measurements to better define changes in the well gradient whereby gamma and temperature sensors can independently detect changes in rock formation surrounding the well.

10. A method according to claim 9, wherein gamma is any background radiation sensor measuring the gamma found in rock formations surrounding the well.

11. A method according to claim 9, wherein changes in gamma measurements are used to alter the calculation of the well's temperature gradient.

12. A method according to claim 9, wherein changes in the calculated temperature gradient is used to alter the calculation of the well's gamma profile.

13. A method for the direct measurement of the well's temperature gradient by placing multiple sets of the plurality of temperature sensors separated by a known distance on a logging tool whereby the well's temperature gradient is directly calculated by taking the difference in temperature measurements over the known distance of separation as the logging tool moves through the well.
